(19) United States
(12) Patent Application Publication
(10) Pub. No.: US 2009/0257863 A1
(43) Pub. Date: Oct. 15, 2009

(54) Turbine assembly

(75) Inventor: Roger Carraro Prioreschi, Antipolo City (PH)

Correspondence Address: Asia Power Dev. Foundation, Inc.;c/o Roger Prioreschi, Emerald Hills, Sta Cruz, Antipolo City, 1780, PH

(73) Assignee: Asia Power Dev. Foundation, Inc., Antipolo City (PH)

(21) Appl. No.: 12/320,606

(22) Filed: Jan. 30, 2009

(30) Foreign Application Priority Data
Apr. 11, 2008 (PH) 1-2008-000115

(51) Int. Cl. F03B 11/02; F03B 3/12

(52) U.S. Cl. 415/200; 416/193 R

(57) ABSTRACT

The ‘hydrokinetic turbine assembly’ is a device for the conversion of the kinetic energy of oscillating tidal currents into rotary torque to generate clean electric power. This device is a horizontal axis hydroturbine with a plurality of trapezoidal symmetrical blades placed at about 45 degrees to the axis. The inclination of the blades assures its maximum energy conversion capacity and the dual reaction function of the turbine where ‘floods and ebbs” are alternatively converted into rotary torque. The inner blade frame, its aerodynamic contour, and at least one connective circumferential blade-ring, add strength buoyancy and sensitivity to slow currents. This hydrokinetic turbine is separated from the electric generators and can be placed in pre-planned current flow locations for greater efficiency.

### TECHNICAL FIELD

The present invention relates generally to a device for generating energy and more particularly to a hydrokinetic turbine assembly.

### BACKGROUND OF THE INVENTION

The balancing of ocean water levels causes powerful tidal currents which can serve as a free energy source in attaining renewable electric power. Numerous methods and devices have already been tested and utilized for harnessing and converting the mechanical (kinetic) energy of oceans into useful electric power, however, their practical implementation had encountered numerous problems on account of its economic and environmental nature.

One of the aforementioned devices is the reaction hydraulic turbine for converting the energy of a flow stream. This turbine is positioned in a manner wherein the lower section of the runner is submerged in water so that it can be rotated by the energy of a flowing stream in the same direction as the stream. The operational efficiency of this turbine may be improved by either increasing the rotating force of the rotating shaft or by increasing the amount of water acting on the blades. The rotating force of the rotating shaft may be increased by enlarging the radius between the rim and rotating shaft of the runner, while the amount of water acting on the blades is increased by enlarging the vertical intersection area of each blade or by enlarging the width of the runner. In a typical reaction hydraulic turbine, the blades are radially attached to the rim of the runner such that the flowing stream of the tides or river meets at right angle with the blades at the lowermost portion of the runner in water so that the energy of the flowing stream may be effectively applied to the blades. However, the energy of the flowing stream does not act on the blades at portions of the runner where it is put into or come out of the water. When the blades are put into or come out of the water, the blades are parallel to the water surface so that a strong hydraulic resistance acts on the blades. The hydraulic resistance acting on the blades offsets a part of the effective hydraulic energy obtained by the blades positioned at the lowermost portion of the runner, thereby resulting in an inferior operational efficiency.

### SUMMARY

The turbine of the present invention is capable of harnessing and converting the kinetic (mechanical) energy of oscillating tidal currents (floods and ebbs) into torque to be transmitted to the electric generators for the production of electric power.

The turbine is provided with blades disposed at a predetermined angle so that it can become a dual reaction turbine that alternately harnesses and converts the oscillating flows of the floods and ebbs into rotary torque without swinging around with the direction of the current. The invention further having blades with distinctive aerodynamic contour which increases the turbine's efficiency and sensitivity to slow currents, thus, allowing immediate “start up” at the beginning of every tidal cycle. It facilitates the flow, minimizes the exit-turbulence and it adds buoyancy and efficiency to the turbine.

Another important feature of the present turbine is that it can be indirectly attached to an electric generator such that it can be submerged in sea water at strategically pre-planned sites at various depths, thus utilizing most of the energy of both cold and warm current with different density.

Other objects and advantages of the present invention can be realized upon reading the following description taken in conjunction with the accompanying drawings.

### BRIEF DESCRIPTION OF THE SEVERAL VIEWS OF THE DRAWINGS

FIG. 1 is a front view of the turbine assembly of the present invention,

FIG. 2 is an isolated and partly cut-out perspective view of the turbine,

FIG. 3 is a cross-sectional view taken along 3-3 of FIG. 1, and

FIG. 4 is a front view showing the protective grid

FIG. 5 is a cut-out view showing an embodiment of the blade member of the present invention, and

FIG. 6 is a profile of the blade member of the present invention.

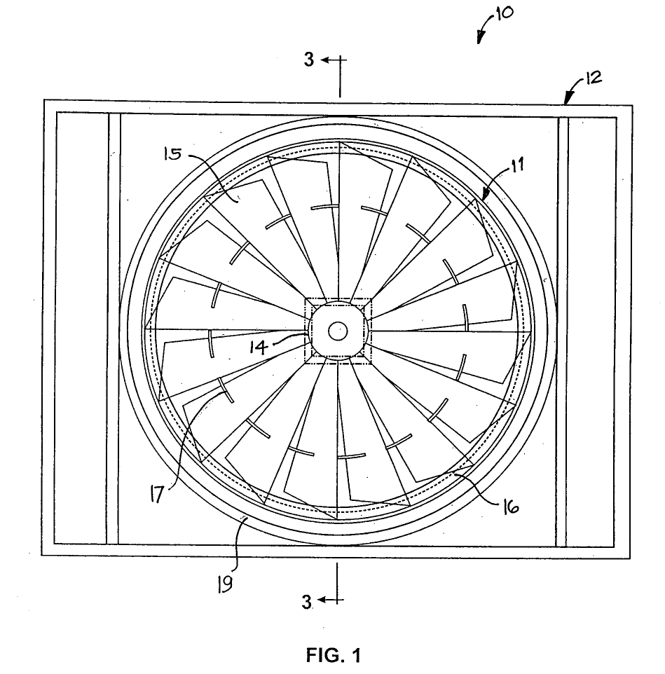

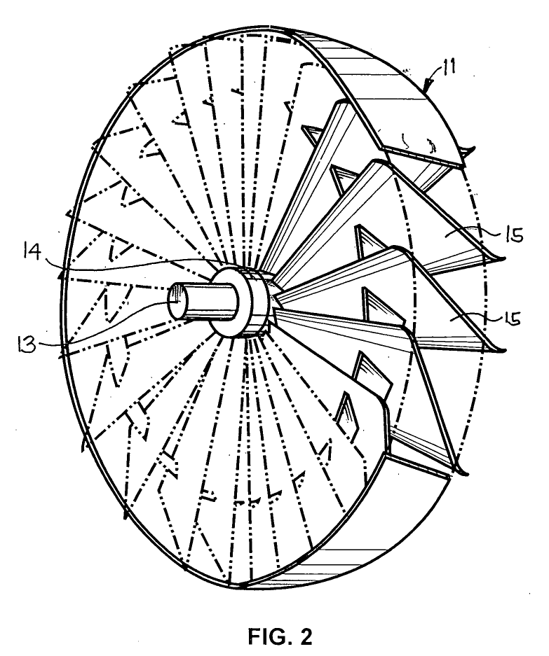

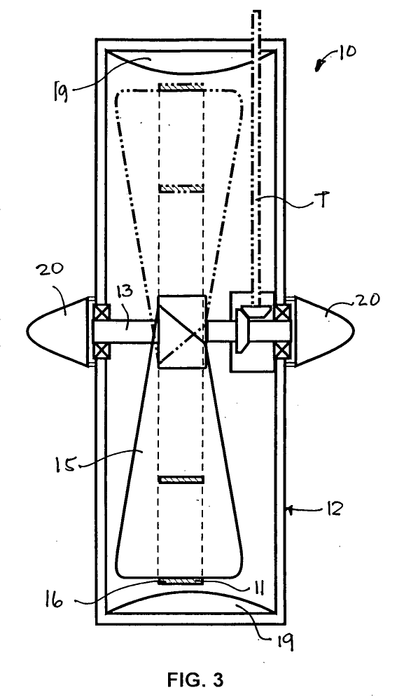

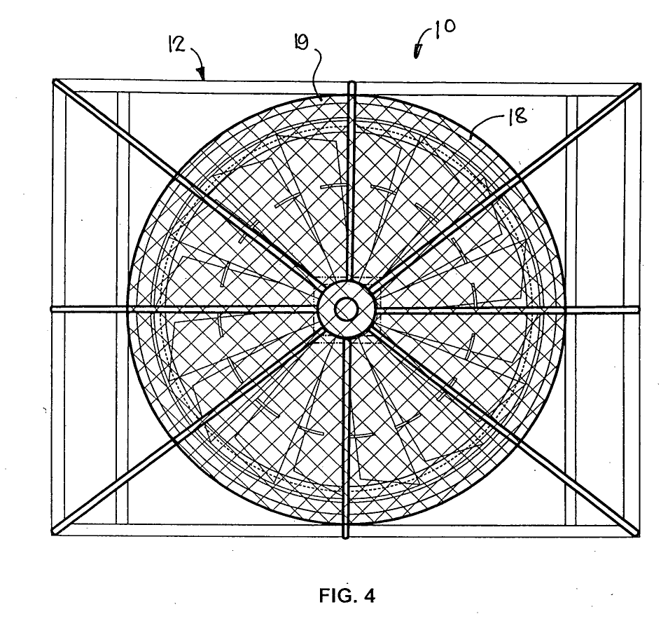

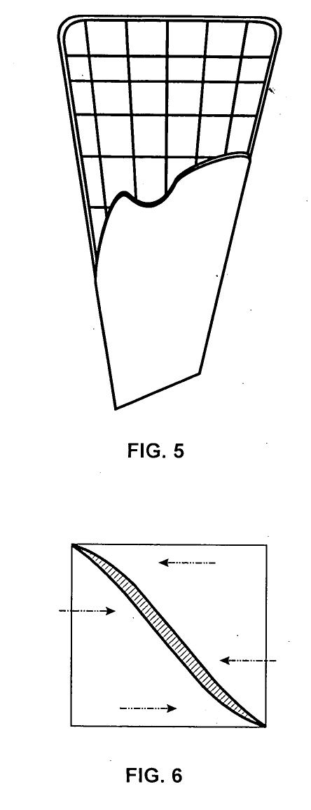

### DETAILED DESCRIPTION OF THE EMBODIMENT OF THE INVENTION

Referring to the drawings, there is shown a turbine assembly generally designated as 10 comprising a turbine member 11 rotatably mounted on cage member 12 through shafting 13 provided thereof. Said turbine member consisting of a hub 14 having a plurality of blade members 15 being held thereof. Each of the blade member having predetermined length and preferably trapezoidal in shape. Said blade member having cross-section being defined by a flattened central section with its upper surfaces descending gradually towards one end and its inner surfaces descending gradually towards the other end. Each of the blade member may be in the form of a framed structure wherein the outer cover is made of non-corrosive light steel material and the frame made of non-corrosive steel material that includes manganese steel or high carbon steel material. Each of the blade members having an inclination angle of about 45 degrees for purposes of dual reaction or function and for a maximum “flood” and “ebb” energy. The angular inclination of each of the blade member allows the lowering of excessive turbine “exit” turbulence in areas of high speed currents. Its trapezoidal shape influences the amount of force generated and makes the turbine sensitive to slow current, thus the turbine starts to rotate normally when the “floods” and “ebbs” begin their cycles There is no need of any “start up” at the beginning or at any change of tidal oscillations. A ring member 16 interconnecting the upper portion of the blade members, and support members 17 provided in-between said blade members and spacedly disposed from the ring member. Said support members are arranged in a manner wherein it can provide rigidity and stability to each of the turbine members under the brunt of enormous volume of flowing water. Cage member 12 is provided with protective grid 18 and means for constricting water flow 19 disposed at the inner section. Mean 19 is being made such that it is capable of defining a throat or entrance wherein the current flow is constricted and directed towards the turbine member and its exit being speed up. Means 19 is preferably a convex circular ring which defines a venturi to the throat or entrance. A flow directing means 20 provided centrally on the front and rear portion of cage member 12 and coaxial with shafting 13.

The turbine assembly is capable of attachment to suitable generator through gear transmission assembly T.

I claim:

1) A turbine assembly comprising:
turbine member being arranged such that it is capable of rotation on a cage member, said turbine member having blade members with their upper section being interconnected and rigidly reinforced, each of the blade members being trapezoidal in shape and disposed in a manner wherein its inclination angle is about 45 degrees, each of the blade members further having a cross-section being defined by a flattened central section with its upper surface gradually descending towards one end and the inner surface gradually descending towards the other end, and said cage member having means for constricting the flow of water towards the turbine member.

2) A turbine assembly according to claim 1 wherein said means for constricting the flow of water is a convex circular ring being held on the inner section of the cage member.

3) A turbine assembly according to claim 1 wherein a flow directing means is provided in the cage member and disposed coaxial with the shafting of the turbine member.

4) A turbine assembly according to claim 1 wherein each of the blade member is a framed structure.

5) A turbine assembly according to claim 5 wherein said framed structure includes non-corrosive frame and cover.

6) A turbine assembly according to claim 6 wherein said non-corrosive frame being made of material that includes manganese steel or high carbon steel and said cover being made of stainless steel.
